(19) United States
(12) Patent Application Publication
(10) Pub. No.: US 2024/0044199 A1
(43) Pub. Date: Feb. 8, 2024

(54) STORAGE DEVICE

(71) Applicant: NIPPON TELEGRAPH AND TELEPHONE CORPORATION, Tokyo (JP)

(72) Inventors: Yosuke SAKURADA, Tokyo (JP); Atsushi ARATAKE, Tokyo (JP); Daisuke UCHIBORI, Tokyo (JP); Yujin HAMANO, Tokyo (JP); Kazuaki WATANABE, Tokyo (JP)

(73) Assignee: NIPPON TELEGRAPH AND TELEPHONE CORPORATION, Tokyo (JP)

(21) Appl. No.: 18/268,937

(22) PCT Filed: Dec. 24, 2020
(86) PCT No.: PCT/JP2020/048562

§ 371 Date: Jun. 21, 2023

(51) Int. Cl. E05F 15/73; E02D 29/14; B64U 80/00

(52) U.S. Cl. CPC E05F 15/73; E02D 29/14; B64U 80/00; E02D 2600/10; E05Y 2900/60; B64U 2101/26

(57) ABSTRACT

A storage device (10) that can be installed in place of a lid of a manhole (100) includes a storage portion (11) that stores an unmanned aerial vehicle (30) and a partition plate (12) that partitions the storage portion (11) and the manhole (100), and the partition plate (12) can slide or be opened and closed.

### TECHNICAL FIELD

The present disclosure relates to a storage device that stores an unmanned aerial vehicle.

### BACKGROUND ART

In recent years, unmanned aerial vehicles (for example, drones, multicopters, or the like) that fly by rotation of a plurality of propellers have been able to be used for inspection of infrastructure structures.

As a method for taking off, landing, and storing such an unmanned aerial vehicle, it is known to use manual hand release and hand catch (Non Patent Literature 1). As another method, it is known to use a ground station that is installed on the ground and autonomously stores an unmanned aerial vehicle (Non Patent Literature 2).

### CITATION LIST

### Non Patent Literature

Non Patent Literature 1: “[Drone Technique] Method and Necessity of Hand Catching of Drone [Notes],” [online], Apr. 8, 2018, [Retrieved on Dec. 15, 2020], Internet <URL:https://www.droneskyfish.com/entry/hand-catch-drone> Non Patent Literature 2: Kenta Tsuchiya, “AIRMADA's Fully Autonomous Drone Station,” [online], Jan. 18, 2017, [Retrieved on Dec. 15, 2020], Internet <URL:https://www.borg.media/airmada-2017-01-18/>

### SUMMARY OF INVENTION

### Technical Problem

However, the method of using hand release and hand catch requires human hands skilled in the operation of an unmanned aerial vehicle. In addition, this method cannot be employed in an automatic inspection system. On the other hand, since it is assumed that the ground station is installed on the ground, it is difficult to install the ground station when the ground station is used in an underground facility. In addition, in the underground facility, accumulated water may be generated due to water leakage or the like, and thus take-off and landing from the floor of the underground facility should be avoided.

An object of the present disclosure made in view of such circumstances is to provide a storage device for an unmanned aerial vehicle for safely and efficiently inspecting an underground facility.

### Solution to Problem

According to an embodiment, there is provided a storage device that is able to be installed in place of a lid of a manhole, the storage device including a storage portion that stores an unmanned aerial vehicle, and a partition plate that partitions the storage portion and the manhole, in which the partition plate is slidable or openable and closable.

### Advantageous Effects of Invention

According to the present disclosure, it is possible to safely and efficiently inspect an underground facility.

### BRIEF DESCRIPTION OF DRAWINGS

FIG. 1 is a view illustrating an outline of an inspection system using a storage device according to an embodiment.

FIG. 2 is a view illustrating an appearance example of an unmanned aerial vehicle according to the embodiment.

FIG. 3 is a block diagram illustrating an internal configuration example of the unmanned aerial vehicle according to the embodiment.

FIG. 4 is a view illustrating an appearance example of a storage portion of the storage device according to the embodiment.

FIG. 5 is a view illustrating a modification of the storage portion of the storage device according to the embodiment.

FIG. 6A is a view illustrating an appearance example of a storage device according to a first embodiment.

FIG. 6B is a view illustrating an appearance example of the storage device according to the first embodiment.

FIG. 7A is a view illustrating an appearance example of a storage device according to a second embodiment.

FIG. 7B is a view illustrating an appearance example of the storage device according to the second embodiment.

FIG. 8A is a view illustrating an appearance example of a storage device according to a third embodiment.

FIG. 8B is a view illustrating an appearance example of the storage device according to the third embodiment.

FIG. 9 is a view illustrating a modification of a partition plate.

FIG. 10 is a view illustrating a modification of an unmanned aerial vehicle.

FIG. 11A is a view illustrating an appearance example of a storage device according to a fourth embodiment.

FIG. 11B is a view illustrating an appearance example of the storage device according to the fourth embodiment.

FIG. 12 is a flowchart illustrating an example of an operation at the time of departure of an unmanned aerial vehicle in the storage device according to the fourth embodiment.

FIG. 13 is a flowchart illustrating an example of an operation when the unmanned aerial vehicle returns in the storage device according to the fourth embodiment.

### DESCRIPTION OF EMBODIMENTS

Hereinafter, a storage device (unmanned aerial vehicle storage device) according to the present disclosure will be described in detail with reference to the drawings. Note that the drawings are only schematically illustrated to the extent that the present invention can be sufficiently understood. Thus, the present invention is not limited only to the illustrated examples. In addition, for convenience of illustration, scales in the drawings may be different from actual scales.

(Inspection System)

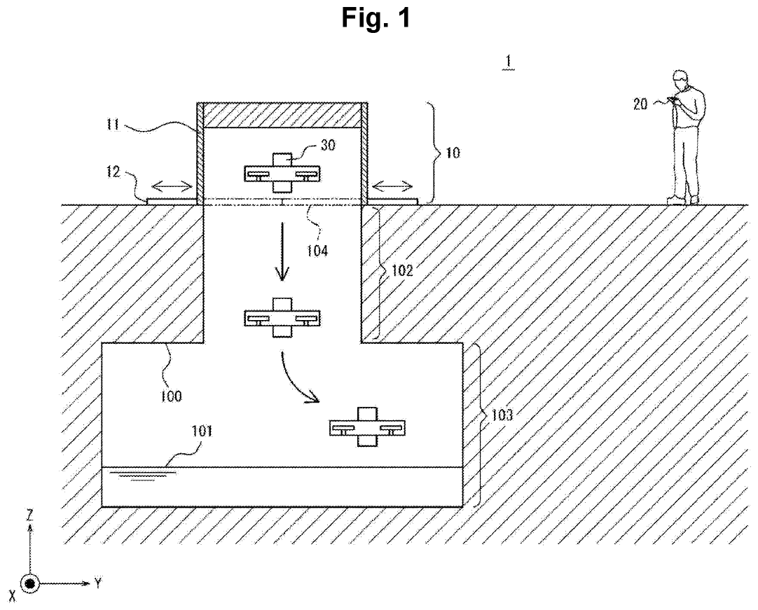

First, an inspection system using a storage device according to the present disclosure will be described. FIG. 1 is a view illustrating an outline of an inspection system 1. The inspection system 1 illustrated in FIG. 1 includes a storage device 10 and an unmanned aerial vehicle 30. The inspection system 1 may further include a terminal device 20. Note that FIG. 1 illustrates a case where the number of unmanned aerial vehicles 30 is one, but the number of unmanned aerial vehicles 30 may be plural. The storage device 10 stores an unmanned aerial vehicle 30 for facility inspection in a manhole 100.

Note that the horizontal direction in the following description means a direction parallel to an XY plane of the coordinate axis display drawn in FIG. 1, and the vertical direction means a direction parallel to a Z axis of the coordinate axis display drawn in FIG. 1.

The manhole 100 is, for example, a communication manhole. The manhole may be referred to as a maintenance hole. The manhole 100 includes a neck portion 102 and a framework portion 103 connected to the neck portion 102. In the infrastructure facility in the manhole 100, accumulated water 101 due to water leakage or the like may be generated on the floor of the framework portion 103.

An opening (manhole hole) 104 of the manhole 100 is an entrance of the manhole 100, and a removable lid is placed so as to close the manhole hole 104. The storage device 10 has a structure that can be installed in the manhole hole 104 in place of the lid of the manhole 100. FIG. 1 illustrates a state in which the storage device 10 is installed in place of the lid of the manhole 100, that is, installed on the upper portion of the neck portion 102.

The storage device 10 includes a storage portion 11 that stores the unmanned aerial vehicle 30, and a partition plate (inner lid) 12 that partitions the storage portion 11 and the manhole 100. By sliding or opening and closing the partition plate 12, the unmanned aerial vehicle 30 can descend in the vertical direction (negative z direction), pass through the manhole hole 104 and the neck portion 102, and fly through the framework portion 103.

The terminal device 20 is carried and operated by an operator (for example, an inspector) U of the unmanned aerial vehicle 30. Wireless communication is performed between the terminal device 20 and the unmanned aerial vehicle 30. The operator U operates the terminal device 20 to control the operation of the unmanned aerial vehicle 30. The unmanned aerial vehicle 30 can fly even without an instruction related to flight control from the terminal device 20.

In the inspection system 1, the unmanned aerial vehicle 30 captures an image of the inside of the manhole 100 (in other words, an aerial image) while autonomously controlling the flight or controlling the flight according to the operation of the terminal device 20 by the operator U. The unmanned aerial vehicle 30 may transmit the captured image data to the terminal device 20. The operator U inspects the inside of the manhole 100 by checking the image data captured by the unmanned aerial vehicle 30. Note that items to be inspected by the operator U are, for example, the presence or absence of abnormality of the inner wall (that is, the wall surface) of the manhole 100, the state of groundwater stored in the underground passage leading to the manhole 100, the state of an object (structures, devices, or the like) installed in the manhole 100, and the like.

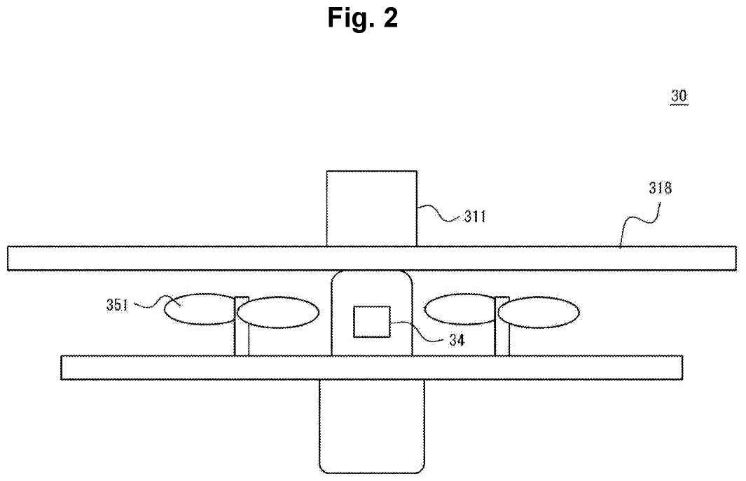

FIG. 2 is a front view illustrating an appearance example of the unmanned aerial vehicle 30. As illustrated in FIG. 2, the unmanned aerial vehicle 30 includes a control box 311 incorporating a control board, four propellers (rotary blades) 351 pivotally supported by a motor (not illustrated), a buffer bumper 318 that absorbs vibration and impact, and a camera 34. The unmanned aerial vehicle 30 may include a plurality of cameras 34.

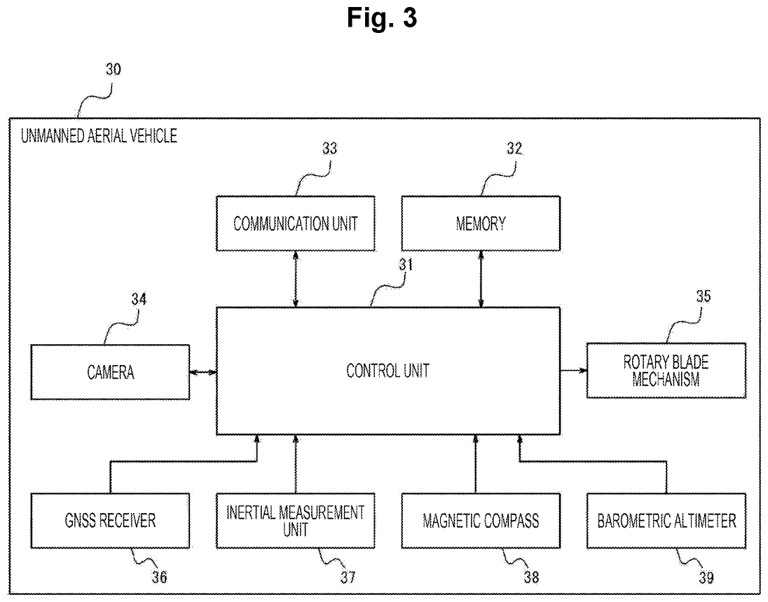

FIG. 3 is a block diagram illustrating an internal configuration example of the unmanned aerial vehicle 30. The unmanned aerial vehicle 30 includes a control unit 31, a memory 32, a communication unit 33, a camera 34, a rotary blade mechanism 35, a GNSS receiver 36, an inertial measurement unit (IMU) 37, a magnetic compass 38, and a barometric altimeter 39.

The communication unit 33 performs wireless communication with the terminal device 20. Examples of the wireless communication method include a wireless LAN such as Wi-Fi (registered trademark) or specified low power radio communication.

The camera 34 captures an image of the surroundings of the unmanned aerial vehicle 30 and generates data of the captured image. The image data of the camera 34 is stored in the memory 32.

The rotary blade mechanism 35 includes a plurality of (for example, four) propellers 351 and a plurality of (for example, four) motors that rotate the plurality of propellers 351.

The GNSS receiver 36 receives a plurality of signals indicating times transmitted from GNSS satellites which are a plurality of navigation satellites and positions (for example, coordinates) of the GNSS satellites. The GNSS receiver 36 calculates the position (that is, the position of the unmanned aerial vehicle 30) of the GNSS receiver 36 on the basis of the plurality of received signals. The GNSS receiver 36 outputs the position information of the unmanned aerial vehicle 30 to the control unit 31.

The inertial measurement unit 37 detects the attitude of the unmanned aerial vehicle 30 and outputs a detection result to the control unit 31. The inertial measurement unit 37 detects, as the attitude of the unmanned aerial vehicle 30, accelerations in three axial directions of forward and rearward, left and right, and up and down of the unmanned aerial vehicle 30, and angular velocities in three axial directions of a pitch axis, a roll axis, and a yaw axis.

The magnetic compass 38 detects a direction of the heading of the unmanned aerial vehicle 30, and outputs a detection result to the control unit 31. The barometric altimeter detects an altitude at which the unmanned aerial vehicle 30 flies, and outputs a detection result to the control unit 31.

The memory 32 stores computer programs and the like necessary for the control unit 31 to control the camera 34, the rotary blade mechanism 35, the GNSS receiver 36, the inertial measurement unit 37, the magnetic compass 38, and the barometric altimeter 39. The memory 32 may be a computer-readable recording medium. The memory 32 may be provided inside the unmanned aerial vehicle 30 or may be provided detachably from the unmanned aerial vehicle 30.

In the present embodiment, the control unit 31 is a processor such as a central processing unit (CPU), a micro processing unit (MPU), a graphics processing unit (GPU), a digital signal processor (DSP), or a system on a chip (SoC), and may be configured by a plurality of processors of the same or different types. The control unit 31 may be configured by dedicated hardware such as an application specific integrated circuit (ASIC), a field-programmable gate array (FPGA), or the like.

The control unit 31 performs signal processing for integrally controlling the operation of each unit of the unmanned aerial vehicle 30, data input/output processing with other units, and data calculation processing. The control unit 31 controls autonomous flight of the unmanned aerial vehicle 30 according to a computer program stored in the memory 32. When autonomously flying, the control unit 31 refers to data such as a flight path and a flight time stored in the memory 32. Note that the control unit 31 may control the flight of the unmanned aerial vehicle 30 in accordance with a command received from the terminal device 20 via the communication unit 33.

The control unit 31 acquires and analyzes image data captured by the camera 34 to specify the environment around the unmanned aerial vehicle 30. The control unit 31 controls the flight to avoid an obstacle, for example, on the basis of the environment around the unmanned aerial vehicle 30. The control unit 31 controls the rotary blade mechanism 35 to control the flight of the unmanned aerial vehicle 30. In the flight control, the position including the latitude, longitude, and altitude of the unmanned aerial vehicle 30 is changed.

The program may be recorded in a recording medium readable by the computer (the unmanned aerial vehicle 30). Using such a recording medium makes it possible to install the program in the computer. Here, the recording medium on which the program is recorded may be a non-transitory recording medium. The non-transitory recording medium is not particularly limited, but may be, for example, a CD-ROM, a DVD-ROM, a Universal Serial Bus (USB) memory, or the like. The program may be downloaded from an external device via a network.

(Storage Portion)

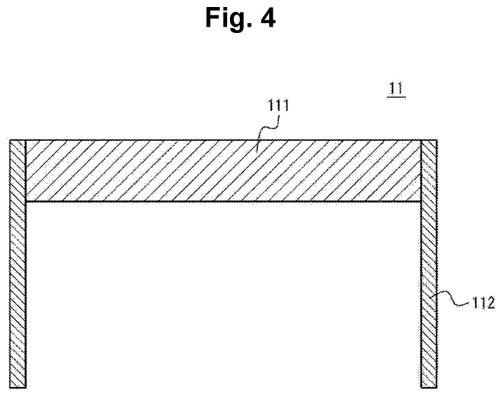

Next, a configuration of the storage portion 11 of the storage device 10 will be described. FIG. 4 is a front view illustrating an appearance example of the storage portion 11. The storage portion 11 is preferably made of a material having a small burden during transportation and high strength. For example, the material of the storage portion 11 is a Mg alloy, an Al alloy, fiber reinforced plastics (FRP), or the like. The storage portion 11 includes a lid 111 and a cylindrical base portion 112. The lid 111 is a lid placed on the ceiling of the base portion 112, but is not an essential configuration.

The inside of the base portion 112 is a cavity, and the unmanned aerial vehicle 30 is stored in the base portion 112. A partition plate 12 to be described later is disposed at the bottom of the base portion 112. The diameter of the base portion 112 is substantially the same as that of the lid of the manhole 100. The base portion 112 has a structure that can be installed in the manhole hole 104 instead of the lid of the manhole 100.

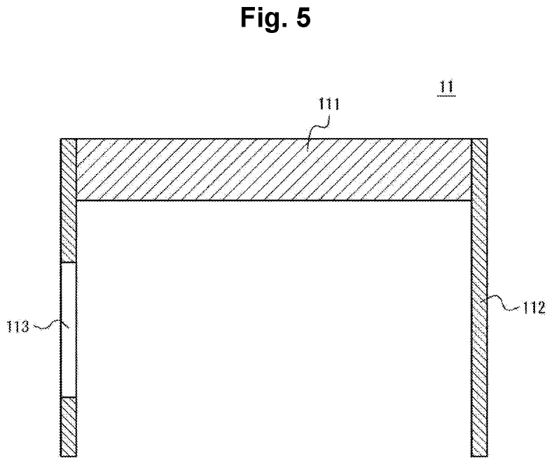

FIG. 5 is a front view illustrating a modification of the storage portion 11. As illustrated in FIG. 5, the storage portion 11 may have a structure in which the inside can be visually recognized. For example, the base portion 112 has, at least in part, a window (transparent material) 113 through which the inside can be seen. The shape of the window 113 is arbitrary, and may be, for example, a lattice shape. The window 113 may be openable and closable. The window 113 desirably has both transparency and strength. For example, the material of the window 113 is a transparent resin material such as acrylic, polyethylene terephthalate (PET), or polycarbonate, or lightweight glass. Alternatively, the storage portion 11 may include a camera or a sensor that detects the presence or absence of an object therein. Accordingly, the position and operation of the unmanned aerial vehicle 30 stored in the storage portion 11 can be ascertained from the outside of the storage device 10.

Next, the configuration of the storage device 10 and the operation of the partition plate 12 will be described with reference to a plurality of embodiments. In the following embodiments, the partition plate 12 has a circular shape, but is not limited thereto. The partition plate 12 is disposed on the bottom surface of the storage device 10 and faces the lid 111. The diameter of the partition plate 12 may be substantially equal to or larger than the maximum diameter of the lid placed on the manhole 100. This can prevent the partition plate 12 from falling into the manhole 100.

### First Embodiment

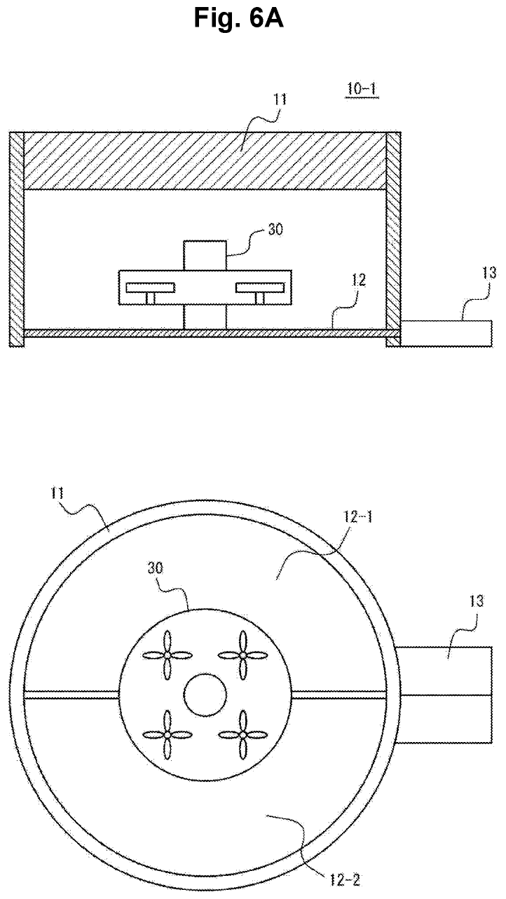

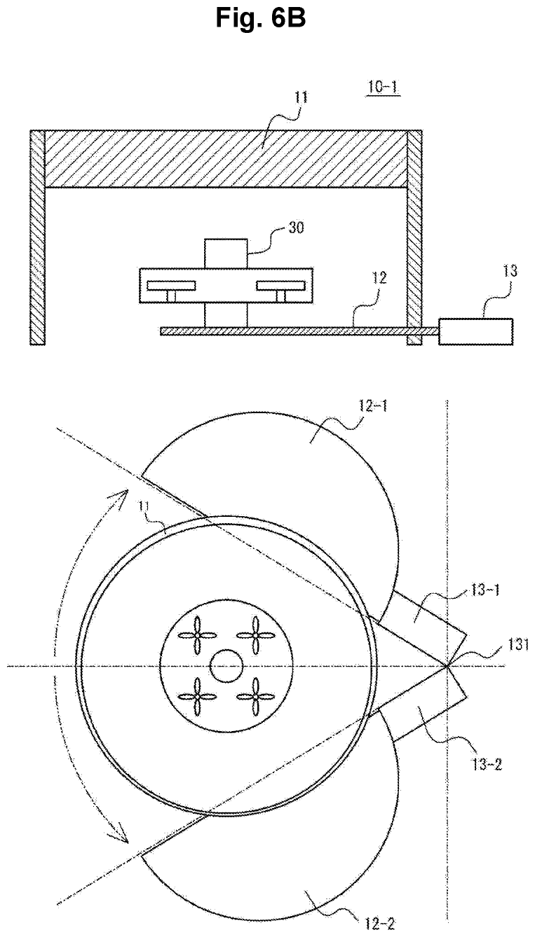

FIG. 6 is a view illustrating an appearance example of a storage device 10-1 according to a first embodiment. FIG. 6A illustrates a state before the partition plate 12 is operated, and FIG. 6B illustrates a state after the partition plate 12 is operated. FIGS. 6A and 6B illustrate a front view and a plan view of the storage device 10-1, respectively. The storage device 10-1 includes a storage portion 11, a partition plate 12, and a handle 13 connected to the partition plate 12.

The partition plate 12 includes a first partition plate 12-1 and a second partition plate 12-2. For example, as illustrated in FIG. 6, the partition plate 12 is divided into halves, and one of the halves is a first partition plate 12-1 and the other half is a second partition plate 12-2.

The handle 13 includes a first handle 13-1 and a second handle 13-2. For example, as illustrated in FIG. 6, the handle 13 is divided into halves, and one of the halves is a first handle 13-1 and the other half is a second handle 13-2. One ends 131 of the first handle 13-1 and the second handle 13-2 are fixed. The other end of the first handle 13-1 is connected to the first partition plate 12-1, and the other end of the second handle 13-2 is connected to the second partition plate 12-2. The first handle 13-1 and the second handle 13-2 each rotationally move in horizontally opposite directions around one end 131 of the handle 13.

The partition plate 12 moves in a sliding manner manually or automatically. Specifically, as illustrated in FIG. 6B, the first partition plate 12-1 and the second partition plate 12-2 each rotationally move in the horizontally opposite directions around one end 131 of the handle 13. That is, when the first partition plate 12-1 rotationally moves clockwise, the second partition plate 12-2 rotationally moves counterclockwise. For example, the first partition plate 12-1 and the second partition plate 12-2 have the same size, and rotationally move by 45 degrees or more at the same timing and at the same speed.

### Second Embodiment

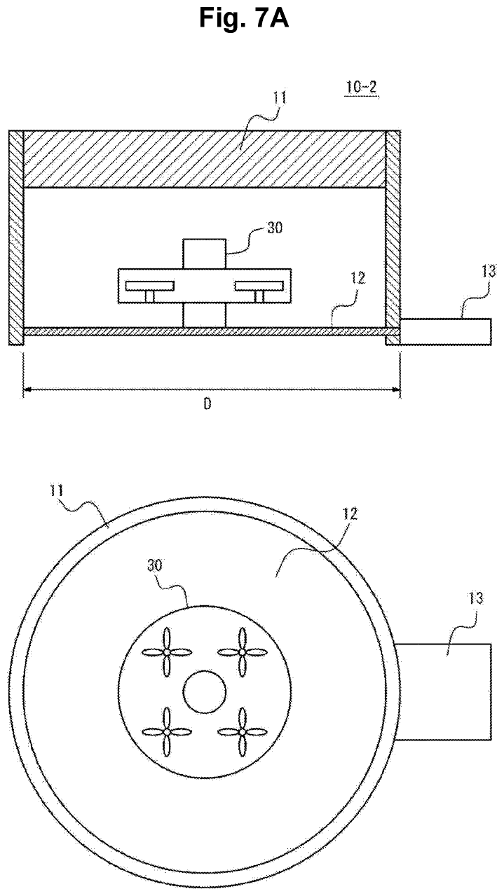

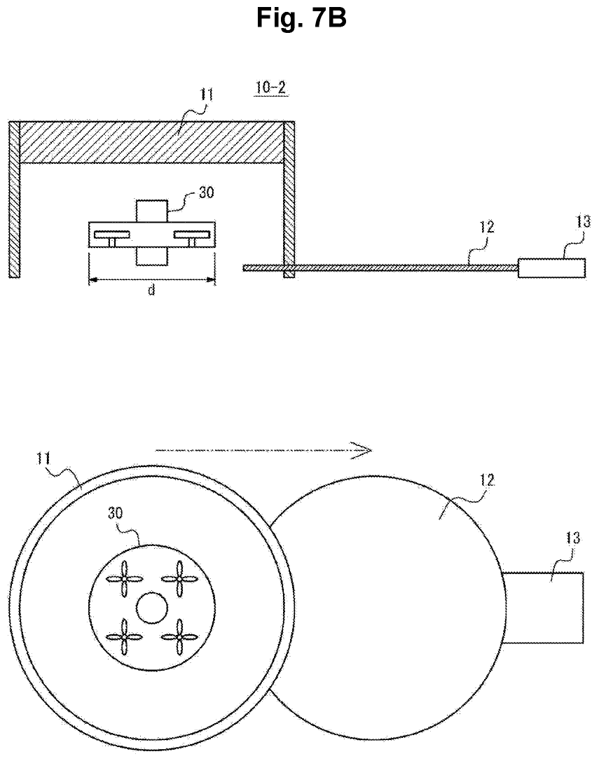

FIG. 7 is a view illustrating a configuration example of a storage device 10-2 according to a second embodiment. FIG. 7A illustrates a state before the partition plate 12 is operated, and FIG. 7B illustrates a state after the partition plate 12 is operated. FIGS. 7A and 7B illustrate a front view and a plan view of the storage device 10-2, respectively. The storage device 10-2 includes a storage portion 11, a partition plate 12, and a handle 13 connected to the partition plate 12.

The partition plate 12 moves in a sliding manner manually or automatically. Specifically, as illustrated in FIG. 7B, the partition plate 12 horizontally moves in parallel on an axis connecting the center of the partition plate 12 and the center of the handle 13. The sliding amount of the partition plate 12 is set to a value larger than a value obtained by subtracting a diameter d of the unmanned aerial vehicle 30 from a diameter D of the partition plate 12.

### Third Embodiment

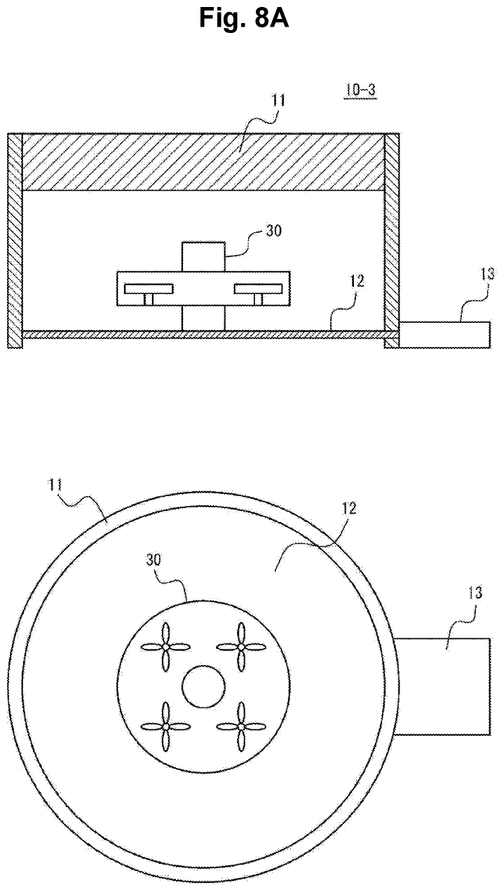

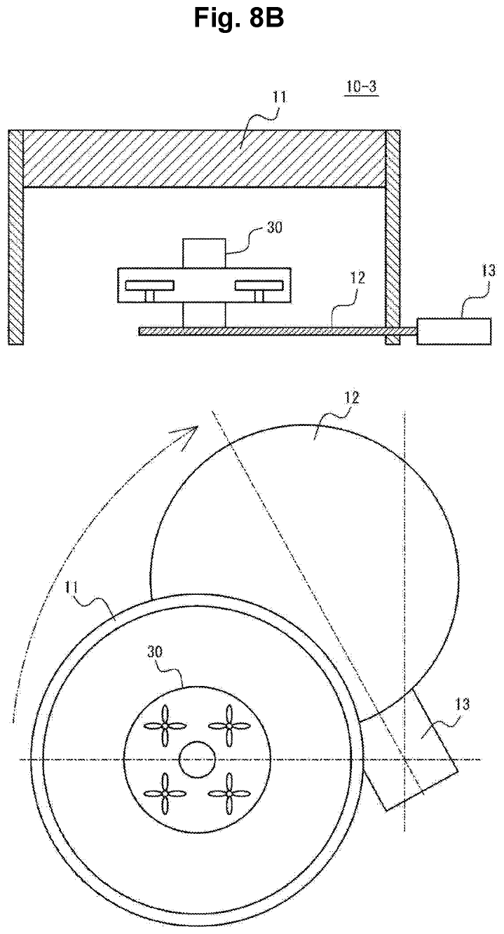

FIG. 8 is a view illustrating a configuration example of a storage device 10-3 according to a third embodiment. FIG. 8A illustrates a state before the partition plate 12 is operated, and FIG. 8B illustrates a state after the partition plate 12 is operated. FIGS. 8A and 8B illustrate a front view and a plan view of the storage device 10-3, respectively. The storage device 10-3 includes a storage portion 11, a partition plate 12, and a handle 13 connected to the partition plate 12.

The partition plate 12 moves in a sliding manner manually or automatically. Specifically, as illustrated in FIG. 8B, the partition plate 12 rotationally moves in the horizontal direction around the handle 13. For example, the partition plate 12 rotationally moves clockwise by 75 to 90 degrees.

The partition plate 12 may move in combination of horizontal parallel movement as described in the second embodiment and rotational movement as described in the present embodiment. This makes it possible to slide the partition plate 12 in various directions. For example, even when the space around the storage device 10-3 is small, the partition plate 12 can be slid in accordance with the surrounding space.

(Modifications)

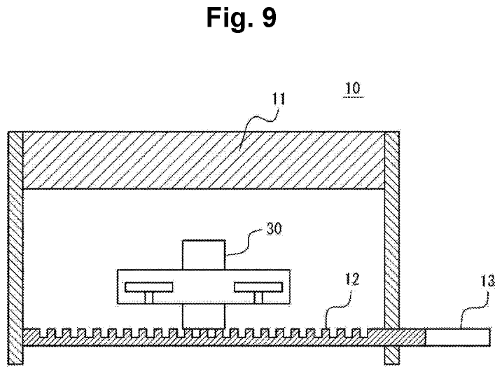

FIG. 9 is a view illustrating a modification of the partition plate 12. As illustrated in FIG. 9, the surface of the partition plate 12 may be subjected to processing (embossing or debossing) for reducing the contact area with the unmanned aerial vehicle 30 to have an uneven shape. According to this modification, it is possible to reduce the influence of friction on the unmanned aerial vehicle 30 when the partition plate 12 is slid in the storage device 10 (10-1, 10-2, 10-3) described above. The surface of the partition plate 12 may be subjected to friction reduction processing (for example, fluorine coating) in order to further reduce the influence of friction due to sliding.

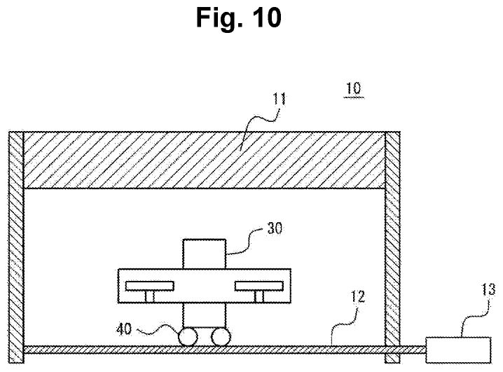

FIG. 10 is a view illustrating a modification of the unmanned aerial vehicle 30. As illustrated in FIG. 10, the unmanned aerial vehicle 30 may include wheels 40 that come into contact with the partition plate 12 in a state of being stored in the storage portion 11. The wheel 40 is, for example, a caster, a ball caster, or the like, and may be of any type. A lightweight material (e.g., plastic such as polyacetal) may be used for the wheel 40. According to this modification, it is possible to reduce the influence of friction on the unmanned aerial vehicle 30 when the partition plate 12 is slid in the storage device 10 (10-1, 10-2, 10-3) described above. The surface of the wheel 40 may be subjected to friction reduction processing (for example, fluorine coating) in order to further reduce the influence of friction due to sliding.

### Fourth Embodiment

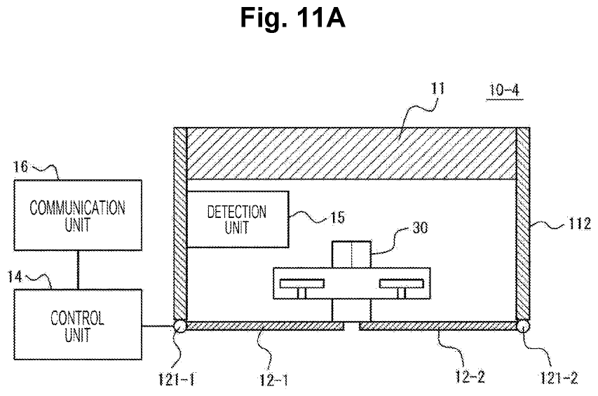

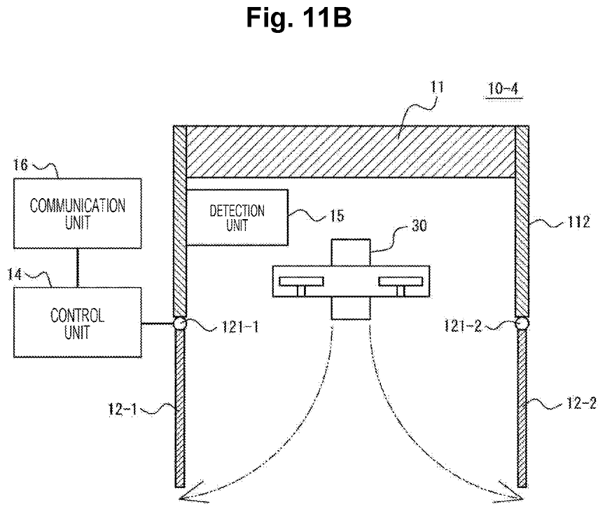

FIG. 11 is a view illustrating a configuration example of a storage device 10-4 according to a fourth embodiment. FIG. 11A illustrates a state before the partition plate 12 is operated, and FIG. 11B illustrates a state after the partition plate 12 is operated. FIGS. 11A and 11B each illustrate front views of the storage device 10-4. The storage device 10-4 includes a storage portion 11, a partition plate 12, a control unit (controller) 14 connected to the partition plate 12, a detection unit 15, and a communication unit 16. In the present embodiment, the diameter of the partition plate 12 is substantially the same as the inner diameter of the storage portion 11.

The detection unit 15 is a camera, a sensor, or the like that detects a state (position, operation, or the like) of the unmanned aerial vehicle 30. The detection unit 15 detects whether or not at least the unmanned aerial vehicle 30 is stored in the storage portion 11 as the position of the unmanned aerial vehicle 30, but it is not necessary to detect a detailed position. In addition, the detection unit 15 detects at least the operation of the propeller 351 as the operation of the unmanned aerial vehicle 30, but it is not necessary to detect a detailed operation. Since the storage device 10-4 includes the detection unit 15, it is possible to transmit information indicating the state of the unmanned aerial vehicle 30 to the communication unit 16 without modifying the unmanned aerial vehicle 30.

The partition plate 12 includes a first partition plate 12-1 and a second partition plate 12-2. For example, as illustrated in FIG. 11, the partition plate 12 is divided into halves, and one of the halves is a first partition plate 12-1 and the other half is a second partition plate 12-2. The first partition plate 12-1 has a connecting portion 121-1 that fixedly and rotatably connects an end portion to the base portion 112 of the storage portion 11. The second partition plate 12-2 has a connecting portion 121-2 that fixedly and rotatably connects an end portion to the base portion 112 of the storage portion 11.

The control unit 14 acquires information indicating the state of the unmanned aerial vehicle 30 from the detection unit 15 via the communication unit 16. The control unit 14 controls operation of the partition plate 12 by controlling the connecting portions 121-1 and 121-2 on the basis of a detection result (that is, information indicating the state of the unmanned aerial vehicle 30) of the detection unit 15. Specifically, as illustrated in FIG. 11B, each of the first partition plate 12-1 and the second partition plate 12-2 rotationally moves by 90 degrees in the vertical direction around the connecting portions 121-1 and 121-2 which are connection points between the end portion and the storage portion 11. The partition plate 12 is opened when the unmanned aerial vehicle 30 departs (exits) from the storage portion 11. The partition plate 12 is closed after the unmanned aerial vehicle 30 returns (enters) to the storage portion 11, and stores the unmanned aerial vehicle 30 in the storage portion 11.

The control unit 14 and the communication unit 16 may be included in a computer capable of executing a program instruction. Here, the computer may be a general-purpose computer, a dedicated computer, a workstation, a personal computer (PC), an electronic note pad, or the like. The program instruction may be a program code, a code segment, or the like for executing required tasks.

The computer includes a processor that functions as the control unit 14, a storage unit (memory), an input interface, an output interface, and a communication interface that functions as the communication unit 16. The processor reads and executes the program from the storage unit to control the operation of the partition plate 12. The input interface is a pointing device, a keyboard, a mouse, or the like, receives a user's input operation, and acquires information based on the user's operation. The output interface is a display, a speaker, or the like, and outputs information.

The program may be recorded in a computer-readable recording medium. Using such a recording medium makes it possible to install the program in the computer. Here, the recording medium on which the program is recorded may be a non-transitory recording medium. The non-transitory recording medium is not particularly limited, but may be, for example, a CD-ROM, a DVD-ROM, a USB memory, or the like. The program may be downloaded from an external device via a network.

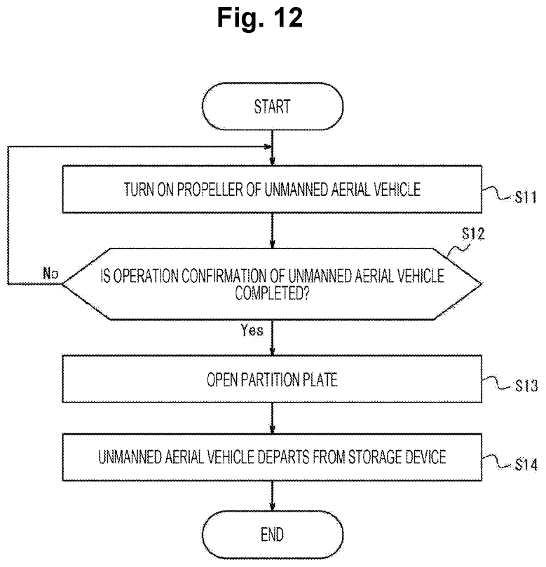

Next, the operation of the storage device 10-4 at the time of departure of the unmanned aerial vehicle 30 will be described with reference to FIG. 12. FIG. 12 is a flowchart illustrating an example of the operation of the storage device 10-4 at the time of departure of the unmanned aerial vehicle 30.

In step S11, the rotary blade mechanism 35 of the unmanned aerial vehicle 30 drives the motor to rotate the propeller 351.

In step S12, the detection unit 15 of the storage device 10-4 confirms the operation of the unmanned aerial vehicle 30. Specifically, the detection unit 15 confirms that the propeller 351 of the unmanned aerial vehicle 30 has rotated and is ready for departure. When the operation confirmation of the unmanned aerial vehicle 30 is completed (Yes in step S12), the storage device 10-4 advances the processing to step S13.

In step S13, the control unit 14 of the storage device 10-4 releases a lock function of the connecting portions 121-1 and 121-2 for keeping the partition plate 12 horizontal. Then, the control unit 14 controls the connecting portions 121-1 and 121-2 to open the partition plate 12.

In step S14, the unmanned aerial vehicle 30 departs from the storage device 10-4 and starts flying to the inside of the manhole 100 connected to the storage device 10-4.

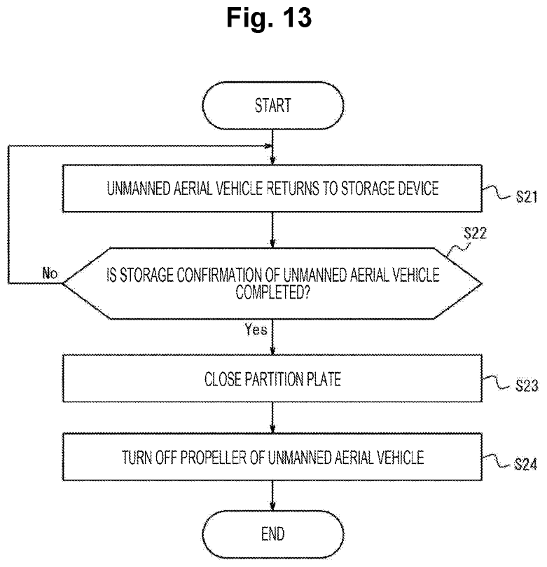

Next, the operation of the storage device 10-4 when the unmanned aerial vehicle 30 returns will be described with reference to FIG. 13. FIG. 13 is a flowchart illustrating an example of the operation of the storage device 10-4 when the unmanned aerial vehicle 30 returns.

In step S21, the unmanned aerial vehicle 30 finishes the inspection of the inside of the manhole 100 and returns to the storage device 10-4.

In step S22, the detection unit 15 of the storage device 10-4 confirms that the unmanned aerial vehicle 30 is stored in the storage portion 11. Specifically, the detection unit 15 confirms that the unmanned aerial vehicle 30 is hovering inside the storage portion 11. When the storage confirmation of the unmanned aerial vehicle 30 is completed (Yes in step S22), the storage device 10-4 advances the processing to step S23.

In step S23, the control unit 14 of the storage device 10-4 controls the connecting portions 121-1 and 121-2 to close the partition plate 12. Then, the control unit 14 sets a lock function of the connecting portions 121-1 and 121-2 and keeps the partition plate 12 horizontal.

In step S24, the rotary blade mechanism 35 of the unmanned aerial vehicle 30 stops the motor to stop the rotation of the propeller 351.

As described above, the storage device 10 can be installed in place of the lid of the manhole 100, and includes the storage portion 11 that stores the unmanned aerial vehicle 30 and the partition plate 12 that partitions the storage portion 11 and the manhole 100, and the partition plate 12 can slide or be opened and closed.

With such a configuration, according to the present disclosure, the departure and return operations of the unmanned aerial vehicle 30 can be automatically performed, and an automatic inspection system can be constructed. Further, according to the present disclosure, since the hand release and the hand catch are not performed, human hands skilled in the operation of the unmanned aerial vehicle 30 are not required.

In addition, according to the present disclosure, since the unmanned aerial vehicle 30 departs from the storage device 10 connected in place of the lid of the manhole 100, it is possible to safely perform the inspection even if the accumulated water 101 is generated on the floor of the manhole 100. In addition, according to the present disclosure, since the storage device 10 can be connected in place of the lid of the manhole 100, the inside of the manhole 100 can be efficiently inspected.

Although the above-described embodiments have been described as representative examples, it is apparent to those skilled in the art that many modifications and substitutions can be made within the spirit and scope of the present disclosure. Therefore, it should not be understood that the present invention is limited by the above-described embodiments, and various modifications or changes can be made without departing from the scope of the claims.

For example, in the storage devices 10-1, 10-2, and 10-3 according to the first to third embodiments, similarly to the storage device 10-4 according to the fourth embodiment, the detection unit 15 that detects the state of the unmanned aerial vehicle 30 and the control unit 14 that controls the operation of the partition plate 12 on the basis of the detection result of the detection unit 15 may be provided. In addition, in the storage device 10-4 according to the fourth embodiment, the surface of the partition plate 12 may have an uneven shape, and the unmanned aerial vehicle 30 may include wheels 40.

### REFERENCE SIGNS LIST

1 Inspection system
10-1, 10-2, 10-3, 10-4 Storage device
11 Storage portion
12 Partition plate
12-1 First partition plate
12-2 Second partition plate
13 Handle
13-1 First handle
13-2 Second handle
14 Control unit
15 Detection unit
16 Communication unit
20 Terminal device
30 Unmanned aerial vehicle
31 Control unit
32 Memory
33 Communication unit
34 Camera
35 Rotary blade mechanism
36 GNSS receiver
37 Inertial measurement unit
38 Magnetic compass
39 Barometric altimeter
40 Wheel
100 Manhole
101 Accumulated water
102 Neck portion
103 Framework portion
104 Manhole hole
111 Lid
112 Base portion
121-1, 121-2 Connecting portion
131 One end
311 Control box
318 Bumper
351 Propeller

1. A storage device that is able to be installed in place of a lid of a manhole, the storage device comprising:
a storage portion that stores an unmanned aerial vehicle; and
a partition plate that partitions the storage portion and the manhole,
wherein the partition plate is slidable to open the storage portion.

2. The storage device according to claim 1, further comprising:
a handle connected to the partition plate,
wherein the partition plate rotationally moves in a horizontal direction around the handle.

3. The storage device according to claim 2,
wherein the partition plate includes a first partition plate and a second partition plate, and
the first partition plate and the second partition plate each rotationally move in horizontally opposite directions around the handle.

4. The storage device according to claim 2, wherein the partition plate moves in parallel on an axis connecting a center of the partition plate and a center of the handle.

5. The storage device according to claim 1,
wherein the partition plate includes a first partition plate and a second partition plate, and
each of the first partition plate and the second partition plate rotationally moves in a vertical direction around a connection point between an end portion and the storage portion.

6. The storage device according to claim 1, further comprising:
a detection unit that detects a state of the unmanned aerial vehicle; and
a control unit that controls an operation of the partition plate based on a detection result of the detection unit.

7. The storage device according to claim 1, wherein a surface of the partition plate has an uneven shape.

8. The storage device according to claim 1, wherein the storage portion has, at least in part, a window through which an inside is able to be seen.

9. The storage device according to claim 3, wherein the partition plate moves in parallel on an axis connecting a center of the partition plate and a center of the handle.

10. The storage device according to claim 2, further comprising:
a detection unit that detects a state of the unmanned aerial vehicle; and
a control unit that controls an operation of the partition plate based on a detection result of the detection unit.

11. The storage device according to claim 3, further comprising:
a detection unit that detects a state of the unmanned aerial vehicle; and
a control unit that controls an operation of the partition plate based on a detection result of the detection unit.

12. The storage device according to claim 4, further comprising:
a detection unit that detects a state of the unmanned aerial vehicle; and
a control unit that controls an operation of the partition plate based on a detection result of the detection unit.

13. The storage device according to claim 5, further comprising:
a detection unit that detects a state of the unmanned aerial vehicle; and
a control unit that controls an operation of the partition plate based on a detection result of the detection unit.

14. The storage device according to claim 6, wherein the state indicates an operation of the unmanned aerial vehicle.

15. The storage device according to claim 10, wherein the state indicates an operation of the unmanned aerial vehicle.

16. The storage device according to claim 11, wherein the state indicates an operation of the unmanned aerial vehicle.

17. The storage device according to claim 12, wherein the state indicates an operation of the unmanned aerial vehicle.

18. The storage device according to claim 13, wherein the state indicates an operation of the unmanned aerial vehicle.

19. A storage device that is able to be installed in place of a lid of a manhole, the storage device comprising:
a storage portion that stores an unmanned aerial vehicle; and
a partition plate that partitions the storage portion and the manhole,
wherein the partition plate is openable to open the storage portion.

20. A storage device that is able to be installed in place of a lid of a manhole, the storage device comprising:
a storage portion that stores an unmanned aerial vehicle; and
a partition plate that partitions the storage portion and the manhole,
wherein the partition plate is closable to close the storage portion.
